(19) United States
(12) Patent Application Publication
(10) Pub. No.: US 2010/0046910 A1
(43) Pub. Date: Feb. 25, 2010

(54) MEDIA SIGNAL SINK AND METHOD FOR PLAYING IMAGE THEREOF

(75) Inventor: Yoo Jin Lim, Gumi-Si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/522,065

(22) PCT Filed: Dec. 27, 2007
(86) PCT No.: PCT/KR07/06892

§ 371 Date: Sep. 28, 2009

(30) Foreign Application Priority Data
Jan. 4, 2007 (KR) 10-2007-0001100

(51) Int. Cl. H04N 5/91

(52) U.S. Cl. 386/66; 386/E05.001

(57) ABSTRACT

A media signal sink (100A) and an image reproduction method thereof are disclosed. The media signal sink (100A) is adapted to selectively reproduce a first image signal and a second image signal, and includes a user command input unit (606) for inputting an image signal switch command signal in a state in which the first image signal is reproduced, a controller (602) responsive to the image signal switch command signal for stopping the reproduction of the first image signal and reproducing the second image signal, and a display unit (604) for displaying an image based on a reproduction operation of the controller (602). When a resumption command signal for the first image signal is inputted through the user command input unit (606), the controller (602) again reproduces the first image signal beginning with a portion of the first signal in which the reproduction of the first image signal has been stopped, in response to the resumption command signal. Therefore, when an image display is performed by selectively reproducing or stopping a plurality of images, it is possible to again reproduce the stopped images seamlessly.

### TECHNICAL FIELD

The present invention relates to media signal processing, and more particularly, to a media signal sink for processing and displaying a plurality of image signals, and an image reproduction method thereof.

### BACKGROUND ART

In general, a media signal sink reproduces image signals provided from various devices or signal sources connected thereto and shows the reproduced image signals to the user through a display unit.

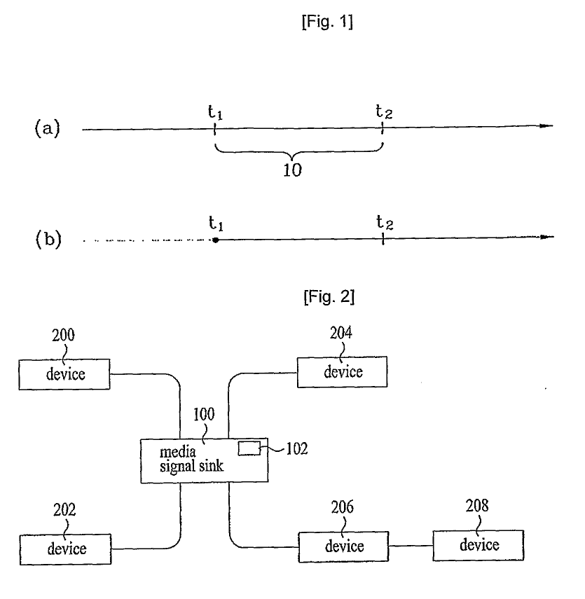

FIG. 1 is a view illustrating the operation of a general media signal sink, in which FIG. 1A shows a state in which a first image signal is reproduced, and FIG. 1B shows a state in which a second image signal is reproduced. Here, the axis of abscissa represents time.

Assume that, while the signal sink processes and displays a first image signal provided from any one device (referred to hereinafter as a ‘first device’ connected thereto as shown in FIG. 1A, the user desires to reproduce and display a second image signal provided from another device (referred to hereinafter as a ‘second device’ connected to the signal sink at a time t1.

In this case, while the signal sink reproduces and displays the second image signal provided from the second device from the first time t1 as shown in FIG. 1B, the first device continuously provides the first image signal to the signal sink in spite of the fact that the signal sink does not display the first image signal provided from the first device.

As a result, there is a problem that, when the signal sink resumes the reproduction and display of the first image signal provided from the first device at a second time t2, the user cannot view an image in a signal sink period 10. In addition, in order to view the image in the period 10, the user has the trouble of having to retrieve that image from the first device.

### DISCLOSURE OF INVENTION

### Technical Problem

An object of the present invention devised to solve the problem lies on a media signal sink which is capable of, when performing an image display by selectively reproducing or stopping a plurality of images, again reproducing the stopped images seamlessly, and an image reproduction method thereof.

### Technical Solution

The object of the present invention can be achieved by providing a media signal sink for selectively reproducing a first image signal and a second image signal, the media signal sink comprising: a user command input unit for inputting an image signal switch command signal in a state in which the first image signal is reproduced; a controller responsive to the image signal switch command signal for stopping the reproduction of the first image signal and reproducing the second image signal; and a display unit for displaying an image based on a reproduction operation of the controller.

The controller, when a resumption command signal for the first image signal is inputted through the user command input unit, may again reproduce the first image signal beginning with a portion of the first image signal in which the reproduction of the first image signal has been stopped, in response to the resumption command signal.

The media signal sink may further comprise a memory for, when the reproduction of the first image signal is stopped, storing information about a corresponding position of the first image signal. In this case, the controller, when the reproduction of the first image signal is resumed, may read the position information from the memory and again reproduce the first image signal beginning with a portion of the first image signal corresponding to the read position information, in which the reproduction of the first image signal has been stopped. Also, the controller may stop the reproduction of the second image signal when the reproduction of the first image signal is resumed.

The media signal sink may further comprise at least one device connected to the media signal sink for providing the first image signal and the second image signal to the media signal sink.

Alternatively, the media signal sink may further comprise at least one signal source connected to the media signal sink for providing the first image signal and the second image signal to the media signal sink.

The media signal sink may further comprise at least one storage unit for storing the first image signal and the second image signal.

The media signal sink may further comprise: at least one device or signal source connected to the media signal sink for providing the first image signal and the second image signal to the media signal sink; and at least one storage unit for storing the first image signal and the second image signal, wherein the first image signal is provided from the device or signal source and the second image signal is provided from the storage unit.

The media signal sink may further comprise a command signal transmitter for selectively transmitting a reproduction command signal or stop command signal generated by the controller to a corresponding one of the device, signal source and storage unit.

The media signal sink may further comprise: an image signal receiver for receiving the first image signal and the second image signal externally inputted thereto; a storage unit for storing the first image signal and second image signal received by the image signal receiver; a storage processor operated under control of the controller for converting the first image signal and second image signal received by the image signal receiver into storage data and storing the converted storage data in the storage unit, or reading the data stored in the storage unit and restoring the read data to the first image signal and second image signal; and an image signal processor for converting the first image signal and second image signal received by the image signal receiver or restored by the storage processor into images displayable by the display unit.

In another aspect of the present invention, provided herein is an image reproduction method of a media signal sink for selectively reproducing a first image signal and a second image signal, the image reproduction method comprising: a) inputting an image signal switch command signal in a state in which the first image signal is reproduced; b) stopping the reproduction of the first image signal and reproducing the second image signal, in response to the image signal switch command signal; and c) displaying an image based on a reproduction operation of the step b).

### ADVANTAGEOUS EFFECTS

The accompanying drawings, which are included to provide a further understanding of the invention, illustrate embodiments of the invention and together with the description serve to explain the principle of the invention.

In the drawings:

FIG. 1 is a view illustrating the operation of a general media signal sink.

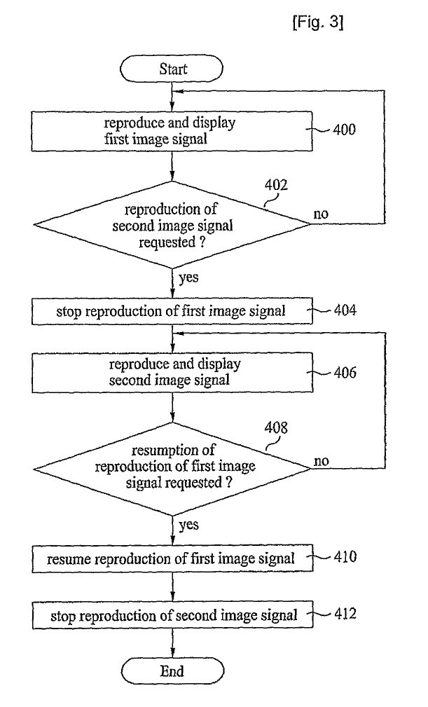

FIG. 2 is a block diagram schematically showing the overall system of a media signal sink and devices according to the present invention.

FIG. 3 is a flowchart illustrating an image reproduction method of the media signal sink according to one embodiment of the present invention.

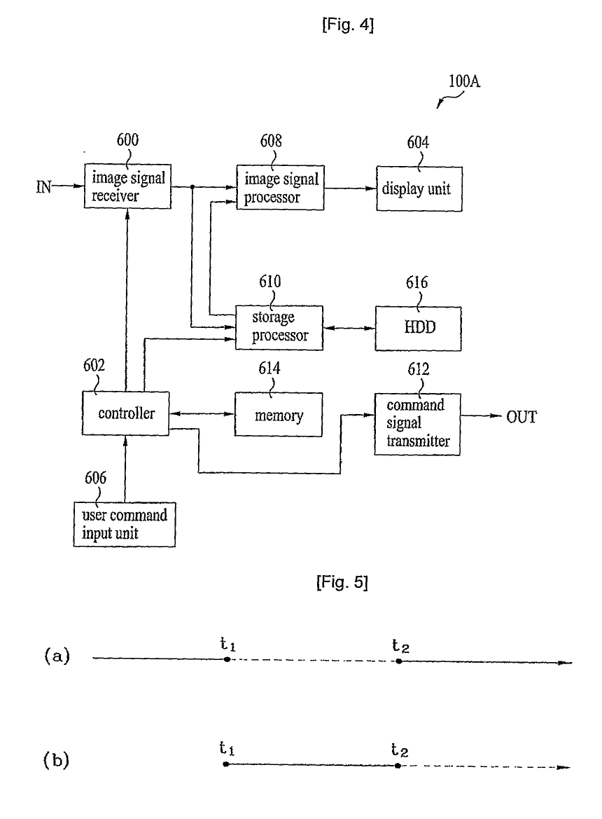

FIG. 4 is a block diagram showing a configuration of the media signal sink according to one embodiment of the present invention.

FIG. 5 is a view illustrating the operation of the media signal sink according to the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts. Besides, although terms used in the present invention are possibly selected from the currently well-known ones, some terms are arbitrarily chosen by the inventor in some cases so that their meanings are explained in detail in the following description. Hence, the present invention should be understood with the intended meanings of the corresponding terms chosen by the inventor instead of the simple names or meanings of the terms themselves.

Hereinafter, for a better understanding of the present invention, the overall system of at least one device and a media signal sink will be described with reference to FIG. 2.

FIG. 2 is a block diagram schematically showing the overall system of devices (or signal sources) and a media signal sink according to the present invention. As shown in FIG. 2, the system comprises a media signal sink 100 having a display unit 102, and devices 200 to 208. Although four devices 200 to 208 are shown to be directly connected to the signal sink 100, more or less than four devices 200 to 208 may be connected to the signal sink 100.

The signal sink 100 receives and processes an audio and/or video signal from each of the devices 200 to 208 and displays a result of the processing through the display unit 102. The signal sink 100 functioning in this manner may be a video display device such as a television (TV), projector or monitor. Also, the signal sink 100 may be at least one device.

Each of the devices 200 to 208 can store, reproduce and/or process an audio and/or video signal. Also, each of the devices 200 to 208 provides an audio and/or video signal to the signal sink 100, and is interfaced with the signal sink 100 via at least one physical port.

In the present invention, the devices 200 to 208 may be signal sources.

Provided that a plurality of signal sources are connected to the signal sink 100 via one physical port in the form of a composite unit, a description of the present invention will be given under the condition that the respective devices 200 to 208 included in the composite unit are regarded as different signal sources.

Applied as each of the devices 200 to 208 or signal sources may be an audio/video source such as a set top box (STB), a personal computer (PC), a video game system, a digital video disc (DVD) recorder, a hard disk drive (HDD) recorder included in an STB or DVD recorder, a home theater system (HTS) or a video cassette recorder (VCR).

Hereinafter, one embodiment of the present invention will be described in association with only devices under the condition that the devices are considered to be the same as signal sources.

The signal sink 100 can be connected with the respective devices 200 to 208 in various interface manners. For example, the devices 200, 206 and 208 may be interfaced with the signal sink 100 in a high-definition multimedia interface (HDMI) manner. In this case, the signal sink 100 and the devices 200, 206 and 208 can be inter-connected via lines for HDMI channels and HDMI-consumer electronics control (CEC) lines. The device 202 may be interfaced with the signal sink 100 in a digital video interface or digital visual interface (DVI) manner, and the device 204 may be connected with the signal sink 100 via a cable. It can be seen from FIG. 2 that the device 208 is connected with the signal sink 100 through the device 206. The devices 200 to 208 shown in FIG. 2 can be wiredly or wirelessly connected with the signal sink 100.

An operation of the signal sink 100 according to one embodiment of the present invention will hereinafter be described with reference to FIG. 2 and FIG. 3.

FIG. 3 is a flowchart illustrating an image reproduction method of the media signal sink according to one embodiment of the present invention.

The signal sink 100 reproduces a first image signal provided from any one of the devices 200 to 208 and shows a result of the reproduction to the user through the display unit 102 (Step 400).

After step 400, while reproducing and displaying the first image signal, the signal sink 100 determines whether reproduction of a second image signal therein is requested by the user (Step 402). The second image signal may be a broadcast image signal previously received and stored in a storage unit 616 (see FIG. 4) by the signal sink (for example, a television) 100, or an image signal provided from any one of the devices 200 to 208.

If it is determined that the reproduction of the second image signal in the signal sink 100 is requested by the user, the signal sink 100 stops the reproduction of the first image signal (Step 404).

After step 404, the signal sink 100 reproduces the second image signal and shows a result of the reproduction to the user through the display unit 102 (Step 406). In the present invention, step 404 and step 406 may be concurrently performed or step 406 may be performed earlier than step 404.

After step 406, the signal sink 100 determines whether resumption (or restoration) of the reproduction of the first image signal therein is requested by the user (Step 408).

If it is determined that the resumption (or restoration) of the reproduction of the first image signal in the signal sink 100 is requested by the user, the signal sink 100 resumes the reproduction of the first image signal beginning with a portion of the first image signal in which the reproduction of the first image signal has been stopped, and displays a result of the reproduction through the display unit 102 (Step 410).

Here, when the reproduction of the first image signal is stopped, a controller 602 (see FIG. 4) stores information about a corresponding position of the first image signal in a memory 614 (see FIG. 4). Thereafter, when the reproduction of the first image signal is resumed, the controller 602 reads the position information from the memory 614 and again reproduces the first image signal beginning with a portion of the first image signal corresponding to the read position information, in which the reproduction of the first image signal has been stopped.

After step 410 in which the reproduction of the first image signal is resumed, it is preferable that the reproduction of the second image signal is stopped (Step 412).

In the present invention, step 410 and step 412 may be concurrently performed or step 412 may be performed earlier than step 410.

Hereinafter, the configuration and operation of a signal sink 100A according to one embodiment of the present invention which performs the image reproduction method shown in FIG. 3 will be described with reference to FIG. 2 to FIG. 5.

FIG. 4 is a block diagram of the signal sink 100A according to one embodiment of the present invention. The signal sink 100A and a display unit 604 shown in FIG. 4 correspond to the signal sink 100 and display unit 102 shown in FIG. 2, respectively.

The signal sink 100A includes an image signal receiver 600, controller 602, display unit 604, user command input unit 606, image signal processor 608, storage processor 610, command signal transmitter 612, memory 614, and storage unit 616. The storage unit 616 can be typically implemented with a hard disk drive (HDD) to store image signals.

Also, in the present invention, the storage unit 616 includes all types of storage devices or recording media that store data readable by various media systems and computer systems. For example, the storage unit 616 may include a ROM, RAM, CD-ROM, magnetic tape, floppy disk, optical data storage device, and Internet Web hard.

The image signal receiver 600 is operated under control of the controller 602 to receive an image signal from each of the devices 200 to 208 through an input terminal IN and output the received image signal to the image signal processor 608 and storage processor 610.

In the case where the signal sink 100A shown in FIG. 4 is a television, the image signal receiver 600 can be implemented with a typical tuner (not shown), demodulator (not shown), and demultiplexer (not shown). The tuner tunes broadcast signals received through an antenna (not shown) under the control of the controller 602 to select a broadcast channel desired by the user. The demodulator demodulates a digital broadcast signal of the channel selected by the tuner. The demultiplexer separates a result of the demodulation by the demodulator into an audio stream, a video stream and a data stream and outputs the separated streams.

Although only the image signal processor 608, which processes video and data streams, is shown in FIG. 4 for the convenience of description, the signal sink of the present invention may further include an audio signal processor (not shown) that processes an audio stream.

In the case where the signal sink 100A shown in FIG. 4 is interfaced with at least one of the devices 200 to 208 in an HDMI manner, the image signal receiver 600 can include an HDMI connector (not shown) and an HDMI receiver (not shown). The HDMI receiver, not shown, receives an image signal transmitted from a device through the HDMI connector and outputs the received image signal to each of the image signal processor 608 and storage processor 610. At this time, the controller 602 transmits a CEC frame to the device through a pin (for example, a pin 13), not shown, of the HDMI connector. Also, the controller 602 receives a CEC frame with a header block and data block transmitted from the device through a pin of the HDMI connector. In addition, the controller 602 performs a CEC line error handling process, CEC frame validation determination process, and CEC frame re-transmission process. Moreover, the controller 602 processes a CEC protocol layer and application layer. The CEC protocol layer is a middleware layer that implements the operation of a CEC protocol, and provides a standard application programming interface (API) for application development. The main function of the CEC protocol layer is to configure and manage a device tree with respect to devices connected to the signal link 100A and manage the status of each device.

Also, under the control of the controller 602, the image signal receiver 600 may selectively receive and output only image signals to be processed by the image signal processor 608, among image signals from the devices 200 to 208 shown in FIG. 2. In addition, when there is no match in image signal format between the signal sink and a device, the image signal receiver 600 may convert the format of an image signal to be processed between the signal sink and the device into an appropriate one.

The storage processor 610 is operated under the control of the controller 602 to store an image signal received by the image signal receiver 600 in the storage unit 616. Also, under the control of the controller 602, the storage processor 610 reads an image signal stored in the storage unit 616 and outputs the read image signal to the image signal processor 608.

The image signal processor 608 reproduces an image signal inputted from the image signal receiver 600 or storage processor 608 into a displayable video/data signal and outputs a result of the reproduction to the display unit 604. A first image signal to be reproduced by the image signal processor 608 is provided from the image signal receiver 600. A second image signal to be reproduced by the image signal processor 608 may be outputted from the image signal receiver 608 or may be read from the storage unit 616 under the control of the storage processor 610. The display unit 604 displays an image corresponding to the reproduction result.

The user command input unit 606 generates a command signal corresponding to a command desired by the user and outputs the generated command signal to the controller 602. The controller 602 controls the respective parts shown in FIG. 4 using a system program stored in the memory 614.

The command signal transmitter 612 transmits various command signals received from the controller 602 to a device transmitting the first image signal, among the devices shown in FIG. 2, through an output terminal OUT. The devices shown in FIG. 2 may have their respective unique logical addresses, and the controller 602 may record and store the logical addresses by devices in the form of a table.

A detailed description will hereinafter be given of the method shown in FIG. 3 that is carried out by the signal sink 100A shown in FIG. 4.

First, step 400 is carried out by the image signal processor 608 and display unit 604.

Thereafter, in order to carry out step 402, the controller 602 determines whether a switch command signal is inputted from the user command input unit 606 while the image signal processor 608 reproduces the first image signal. When reproduction of the second image signal by the image signal processor 608 is requested by the user while the first image signal is reproduced by the image signal processor 608, the user command input unit 606 generates the switch command signal and provides it to the controller 602.

In order to carry out steps 404 and 406, the controller 602 controls the image signal receiver 600, command signal transmitter 612 and/or storage processor 610 in response to the switch command signal to stop the reproduction of the first image signal and reproduce the second image signal. Hereinafter, a device providing the first image signal will be referred to as a first device.

Assume that the first image signal is provided from the image signal receiver 600 and the second image signal is provided from the storage unit (or HDD) 616. At this time, the controller 602 generates a stop command signal to inhibit the first image signal from being provided to the image signal processor 608 through the image signal receiver 600, and transmits the generated stop command signal to the first device together with a logical address of the first device through the command signal transmitter 612.

As a result, the first device stops the transmission of the first image signal to the signal sink 100A in response to the stop command signal.

Also, the controller 602 controls the storage processor 610 such that the second image signal is read from the HDD 616 and provided to the image signal processor 608.

On the other hand, assume that both the first and second image signals are provided from the image signal receiver 600. In this case, the controller 602 controls the image signal receiver 600 such that the second image signal is provided to the image signal processor 608, and, as stated previously, generates the stop command signal to inhibit the first image signal from being provided to the image signal processor 608 and transmits the generated stop command signal to the first device to control it.

In order to carry out step 408, the controller 602 determines whether a resumption command signal is provided from the user command input unit 606. When the reproduction of the first image signal is requested again, the user command input unit 606 generates the resumption command signal and provides it to the controller 602.

In order to carry out steps 410 and 412, in response to the resumption command signal, the controller 602 again reproduces the first image signal beginning with a portion of the first image signal in which the reproduction of the first image signal has been stopped, and stops the reproduction of the second image signal.

Assume that the first image signal is provided from the image signal receiver 600 and the second image signal is provided from the storage unit (or HDD) 616. In this case, the controller 602 controls the storage processor 610 to inhibit the second image signal from being read from the storage unit (or HDD) 616 and provided to the image signal processor 608. Also, the controller 602 generates a transmission command signal requesting re-transmission of the first image signal, and transmits the generated transmission command signal to the first device together with the logical address of the first device. As a result, in response to the transmission command signal, the first device re-transmits the first image signal to the signal sink 100A beginning with a portion of the first image signal in which the reproduction of the first image signal has been stopped.

On the other hand, assume that both the first and second image signals are provided from the image signal receiver 600. In this case, the controller 602 controls the image signal receiver 600 as stated previously such that the first image signal is provided to the image signal processor 608 through the image signal receiver 600, and also controls the image signal receiver 600 to inhibit the second image signal from being provided to the image signal processor 608.

FIG. 5 is a view illustrating the operation of the media signal sink according to the present invention, in which FIG. 5A shows a state in which the first image signal is reproduced, and FIG. 5B shows a state in which the second image signal is reproduced. Here, the axis of abscissa represents time, a solid line represents a time for which reproduction is performed, and a dotted line represents a time for which reproduction is stopped.

Assume that, while the first image signal is reproduced and displayed as shown in FIG. 5A, the reproduction of the second image signal is started at a time t1.

In this case, the signal sink stops the reproduction and display of the first image signal and begins to reproduce and display the second image signal, from the first time t1, as shown in FIG. 5B.

When the user desires to resume the reproduction of the first image signal at a second time t2, the signal sink 100 or 100A according to the present invention stops the reproduction of the second image signal at the time t2. Also, at the time t2, the signal sink 100 or 100A resumes the reproduction of the first image signal beginning with a portion of the first image signal at the time t1 at which the reproduction of the first image signal has been stopped.

As a result, for the period 10 from the time t1 at which the reproduction of the first image signal is stopped until the time t2 at which the reproduction of the first image signal is resumed, as shown in FIG. 1A, the first image signal is not transmitted from the first device to the signal sink. Therefore, the first image signal can be reproduced in succession beginning with a portion whose reproduction has been previously stopped.

### INDUSTRIAL APPLICABILITY

As apparent from the above description, according to the present invention, when reproduction of a second image signal is requested in a state in which a first image signal provided from the a first device is reproduced, the reproduction of the first image signal is automatically stopped. Thereafter, when the reproduction of the first image signal is resumed, the first image signal is reproduced in succession beginning with a portion whose reproduction has been previously stopped. Therefore, the user can seamlessly view an image corresponding to the first image signal. Also, it is possible to prevent unnecessary signal transmission of the device providing the first image signal.

Other implementations are within the scope of the following claims.

1. A media signal sink for selectively reproducing a first image signal and a second image signal, the media signal sink comprising:
a user command input unit for inputting an image signal switch command signal in a state in which the first image signal is reproduced;
a controller responsive to the image signal switch command signal for stopping the reproduction of the first image signal and reproducing the second image signal; and
a display unit for displaying an image based on a reproduction operation of the controller.

2. The media signal sink according to claim 1, wherein the controller, when a resumption command signal for the first image signal is inputted through the user command input unit, again reproduces the first image signal beginning with a portion of the first image signal in which the reproduction of the first image signal has been stopped, in response to the resumption command signal.

3. The media signal sink according to claim 2, further comprising a memory for, when the reproduction of the first image signal is stopped, storing information about a corresponding position of the first image signal,
wherein the controller, when the reproduction of the first image signal is resumed, reads the position information from the memory and again reproduces the first image signal beginning with a portion of the first image signal corresponding to the read position information, in which the reproduction of the first image signal has been stopped.

4. The media signal sink according to claim 2, wherein the controller stops the reproduction of the second image signal when the reproduction of the first image signal is resumed.

5. The media signal sink according to claim 1, further comprising at least one device connected to the media signal sink for providing the first image signal and the second image signal to the media signal sink.

6. The media signal sink according to claim 1, further comprising at least one signal source connected to the media signal sink for providing the first image signal and the second image signal to the media signal sink.

7. The media signal sink according to claim 1, further comprising at least one storage unit for storing the first image signal and the second image signal.

8. The media signal sink according to claim 1, further comprising:
at least one device or signal source connected to the media signal sink for providing the first image signal and the second image signal to the media signal sink; and
at least one storage unit for storing the first image signal and the second image signal,
wherein the first image signal is provided from the device or signal source and the second image signal is provided from the storage unit.

9. The media signal sink according to claim 8, further comprising a command signal transmitter for selectively transmitting a reproduction command signal or stop command signal generated by the controller to a corresponding one of the device, signal source and storage unit.

10 . The media signal sink according to claim 1, further comprising:
an image signal receiver for receiving the first image signal and the second image signal externally inputted thereto;
a storage unit for storing the first image signal and second image signal received by the image signal receiver;
a storage processor operated under control of the controller for converting the first image signal and second image signal received by the image signal receiver into storage data and storing the converted storage data in the storage unit, or reading the data stored in the storage unit and restoring the read data to the first image signal and second image signal; and
an image signal processor for converting the first image signal and second image signal received by the image signal receiver or restored by the storage processor into images displayable by the display unit.

11. An image reproduction method of a media signal sink for selectively reproducing a first image signal and a second image signal, the image reproduction method comprising:
a) inputting an image signal switch command signal in a state in which the first image signal is reproduced;
b) stopping the reproduction of the first image signal and reproducing the second image signal, in response to the image signal switch command signal; and
c) displaying an image based on a reproduction operation of the step b).

12. The image reproduction method according to claim 11, wherein the step b) comprises, when a resumption command signal for the first image signal is inputted, again reproducing the first image signal beginning with a portion of the first image signal in which the reproduction of the first image signal has been stopped, in response to the resumption command signal.

13. The image reproduction method according to claim 12, further comprising, when the reproduction of the first image signal is stopped, storing information about a corresponding position of the first image signal in a memory,
wherein the step b) comprises, when the reproduction of the first image signal is resumed, reading the position information from the memory and again reproducing the first image signal beginning with a portion of the first image signal corresponding to the read position information, in which the reproduction of the first image signal has been stopped.

14. The image reproduction method according to claim 12, wherein the step b) comprises stopping the reproduction of the second image signal when the reproduction of the first image signal is resumed.

15. The image reproduction method according to claim 11, further comprising providing the first image signal and the second image signal to the media signal sink through at least one device connected to the media signal sink.

16. The image reproduction method according to claim 11, further comprising providing the first image signal and the second image signal to the media signal sink through at least one signal source connected to the media signal sink.

17. The image reproduction method according to claim 11, further comprising storing the first image signal and the second image signal in at least one storage unit.

18. The image reproduction method according to claim 11, further comprising:
providing the first image signal and the second image signal to the media signal sink through at least one device or signal source connected to the media signal sink; and
storing the first image signal and the second image signal in at least one storage unit,
wherein the first image signal is provided from the device or signal source and the second image signal is provided from the storage unit.

19. The image reproduction method according to claim 18, further comprising selectively transmitting a reproduction command signal or stop command signal generated at the step b) to a corresponding one of the device, signal source and storage unit.

20. The image reproduction method according to claim 11, further comprising:
d) receiving the first image signal and the second image signal externally inputted;
e) storing the first image signal and second image signal received at the step d) in a storage unit;
f) under control of the step b), converting the first image signal and second image signal received at the step d) into storage data and storing the converted storage data in the storage unit, or reading the data stored in the storage unit and restoring the read data to the first image signal and second image signal; and
g) converting the first image signal and second image signal received at the step d) or restored at the step f) into images displayable at the step c).
